(19) United States
(12) Patent Application Publication
(10) Pub. No.: US 2026/0333310 A1
(43) Pub. Date: Oct. 22, 2026

(54) METHOD AND APPARATUS USED FOR POSITIONING

(71) Applicants: Bunker Hill Technologies LLC, Allen, TX (US); SHANGHAI LANGBO COMMUNICATION TECHNOLOGY COMPANY LIMITED, Shanghai (CN)

(72) Inventors: Jin LIU, Shanghai (CN); Xiaobo ZHANG, Shanghai (CN)

(21) Appl. No.: 19/105,753

(22) PCT Filed: Aug. 28, 2023
(86) PCT No.: PCT/CN2023/115172

§ 371 Date: Feb. 21, 2025

(30) Foreign Application Priority Data
Aug. 31, 2022 (CN) 202211062028.9

(51) Int. Cl. H04W 72/0446; H04W 64/00; H04W 72/40

(52) U.S. Cl. CPC H04W 72/0446; H04W 64/006; H04W 72/40

(57) ABSTRACT

Disclosed in the present application are a method and apparatus used for positioning. A first transmitter transmits a first signal on a sidelink, wherein the type of the first signal is used for determining sending timing of a first time unit, and the first time unit comprises a time domain resource occupied by the first signal; candidates of the type of the first signal comprise a first-type signal and a second-type signal; and the first-type signal comprises a reference signal used for sidelink positioning, and the second-type signal is carried in a physical sidelink channel. According to the present application, the positioning and timing performance is improved, and the hardware complexity and costs can be reduced.

### RELATED APPLICATIONS

This application is a National Stage under 35 USC 371 of and claims priority to International Application No. PCT/CN2023/115172, filed Aug. 28, 2023, which claims the priority benefit of CN Application No. 202211062028.9, filed Aug. 31, 2022.

### TECHNICAL FIELD

The present application relates to a transmission method and device in a wireless communication system, and more particularly to a scheme and device related to positioning timing in wireless communication.

### BACKGROUND ART

Positioning is an important application in the field of wireless communications. The emergence of new applications such as V2X (Vehicle to everything) or industrial Internet of Things has put forward higher requirements for positioning accuracy or latency. In the 3GPP (3rd Generation Partner Project) RAN (Radio Access Network) #94e meeting, a research project on positioning enhancement was launched.

### SUMMARY OF THE INVENTION

According to the work plan in RP-213588, NR Rel-18 needs to support enhanced positioning technology for sidelink positioning (SL Positioning), among which the mainstream sidelink positioning technologies include SL RTT technology, SL AOA, SL TDOA and SL AOD, etc., and the execution of these technologies depends on the measurement of SL PRS (Sidelink Positioning Reference Signal). Since the sender of SL PRS may be mobile, the traditional positioning process or location information feedback scheme needs to be further enhanced.

In response to the above problems, the present application discloses a solution for timing positioning. It should be noted that in the description of the present application, only the V2X scenario is used as a typical application scenario or example; the present application is also applicable to scenarios other than V2X facing similar problems, such as public safety (Public Safety), industrial Internet of Things, etc., and achieves technical effects similar to those in the NR V2X scenario. In addition, although the motivation of the present application is for the scenario where the sender of the wireless signal used for positioning measurement is mobile, the present application is still applicable to the scenario where the sender of the wireless signal used for positioning measurement is fixed, such as RSU (Road Side Unit). Using a unified solution for different scenarios also helps to reduce hardware complexity and cost. In the absence of conflict, the embodiments and features in any node of the present application can be applied to any other node. In the absence of conflict, the embodiments and features in the embodiments of the present application can be arbitrarily combined with each other.

If necessary, reference may be made to 3GPP standards TS38.211, TS38.212, TS38.213, TS38.214, TS38.215, TS38.321, TS38.331, TS38.305, TS37.355 to assist in understanding the present application.

The present application discloses a method in a first node used for wireless communication, characterized by comprising:
sending a first signal on a secondary link;

The type of the first signal is used to determine the sending timing of the first time unit, and the first time unit includes the time domain resources occupied by the first signal; the candidates for the type of the first signal include first type signals and second type signals; the first type signal includes a reference signal used for sub-link positioning, and the second type signal is carried on a physical sub-link channel.

As an embodiment, the problem to be solved by the present application is that the timing adjustment of the first time unit affects the accuracy of the secondary link positioning.

As an embodiment, the method of the present application is: establishing a relationship between the sending timing of the first time unit and the type of the first signal.

As an embodiment, the method of the present application is: dividing the first signal into two types.

As an embodiment, the method of the present application helps the sender of the first signal to flexibly adjust the sending timing.

As an embodiment, the method of the present application is helpful in reducing the complexity of timing adjustment.

As an embodiment, the method of the present application is helpful in saving the signaling overhead of timing adjustment.

According to one aspect of the present application, the above method is characterized in that, when the type of the first signal is the first category signal, whether the time domain resources occupied by the first signal are used within a first time window to determine the sending timing of the first time unit.

According to one aspect of the present application, the above method is characterized in that, when the type of the first signal is the second type of signal, the sending timing of the first time unit is the uplink sending timing of the first node.

According to one aspect of the present application, the above method is characterized in that the type of the first signal is the first type of signal; when the time domain resources occupied by the first signal are within the first time window, the sending timing of the first time unit is the first sending timing; when the time domain resources occupied by the first signal are outside the first time window, the sending timing of the first time unit is the uplink sending timing of the first node.

According to one aspect of the present application, the above method is characterized in that the multiple first-type signals sent by the first node in the first time window all adopt the first sending timing.

According to one aspect of the present application, the above method is characterized in that the first sending timing remains unchanged within the first time window.

According to one aspect of the present application, the above method is characterized in that the first node is a user equipment (UE, User Equipment).

According to one aspect of the present application, the above method is characterized in that the first node is a relay node.

According to one aspect of the present application, the above method is characterized in that the first node is an RSU.

The present application discloses a method used in a second node of wireless communication, characterized by comprising:
receiving the first signal on a secondary link;

The type of the first signal is used to determine the sending timing of the first time unit, and the first time unit includes the time domain resources occupied by the first signal; the candidates for the type of the first signal include first type signals and second type signals; the first type signal includes a reference signal used for sub-link positioning, and the second type signal is carried on a physical sub-link channel.

According to one aspect of the present application, the above method is characterized in that, when the type of the first signal is the first category signal, whether the time domain resources occupied by the first signal are used within a first time window to determine the sending timing of the first time unit.

According to one aspect of the present application, the above method is characterized in that, when the type of the first signal is the second type of signal, the sending timing of the first time unit is the uplink sending timing of the sender of the first signal.

According to one aspect of the present application, the above method is characterized in that the type of the first signal is the first type of signal; when the time domain resources occupied by the first signal are within the first time window, the sending timing of the first time unit is the first sending timing; when the time domain resources occupied by the first signal are outside the first time window, the sending timing of the first time unit is the uplink sending timing of the sender of the first signal.

According to one aspect of the present application, the above method is characterized in that the multiple first-category signals sent by the sender of the first signal in the first time window all adopt the first sending timing.

According to one aspect of the present application, the above method is characterized in that the first sending timing remains unchanged within the first time window.

According to one aspect of the present application, the above method is characterized in that the second node is a user equipment.

According to one aspect of the present application, the above method is characterized in that the second node is a relay node.

According to one aspect of the present application, the above method is characterized in that the second node is an RSU.

The present application discloses a first node used for wireless communication, characterized in that it includes:

A first transmitter, sending a first signal on a secondary link;

The type of the first signal is used to determine the sending timing of the first time unit, and the first time unit includes the time domain resources occupied by the first signal; the candidates for the type of the first signal include first type signals and second type signals; the first type signal includes a reference signal used for sub-link positioning, and the second type signal is carried on a physical sub-link channel.

The present application discloses a second node used for wireless communication, characterized in that it includes:

A first receiver receives a first signal on a secondary link;

The type of the first signal is used to determine the sending timing of the first time unit, and the first time unit includes the time domain resources occupied by the first signal; the candidates for the type of the first signal include first type signals and second type signals; the first type signal includes a reference signal used for sub-link positioning, and the second type signal is carried on a physical sub-link channel.

### BRIEF DESCRIPTION OF THE DRAWINGS

Other features, objects and advantages of the present application will become more apparent by reading the detailed description of non-limiting embodiments with reference to the following drawings:

FIG. 1 shows a processing flow chart of a first node according to an embodiment of the present application;

FIG. 2 shows a schematic diagram of a network architecture according to an embodiment of the present application;

FIG. 3 shows a schematic diagram of a wireless protocol architecture of a user plane and a control plane according to an embodiment of the present application;

FIG. 4 shows a schematic diagram of a first communication device and a second communication device according to an embodiment of the present application;

FIG. 5 shows a structural diagram of UE positioning according to an embodiment of the present application;

FIG. 6 shows a wireless signal transmission flow chart according to an embodiment of the present application;

FIG. 7 shows a flowchart of determining the sending timing of the first time unit according to an embodiment of the present application;

a schematic diagram showing a relationship between a first transmission timing and an uplink transmission timing according to an embodiment of the present application;

FIG. 9 shows a schematic diagram of a first time window according to an embodiment of the present application;

FIG. 10 shows a structural block diagram of a processing device used in a first node according to an embodiment of the present application;

FIG. 11 shows a structural block diagram of a processing device used in a second node according to an embodiment of the present application.

### DETAILED DESCRIPTION

The technical solution of the present application will be further described in detail below in conjunction with the accompanying drawings. It should be noted that, in the absence of conflict, the embodiments of the present application and the features in the embodiments can be arbitrarily combined with each other.

### EXAMPLE 1

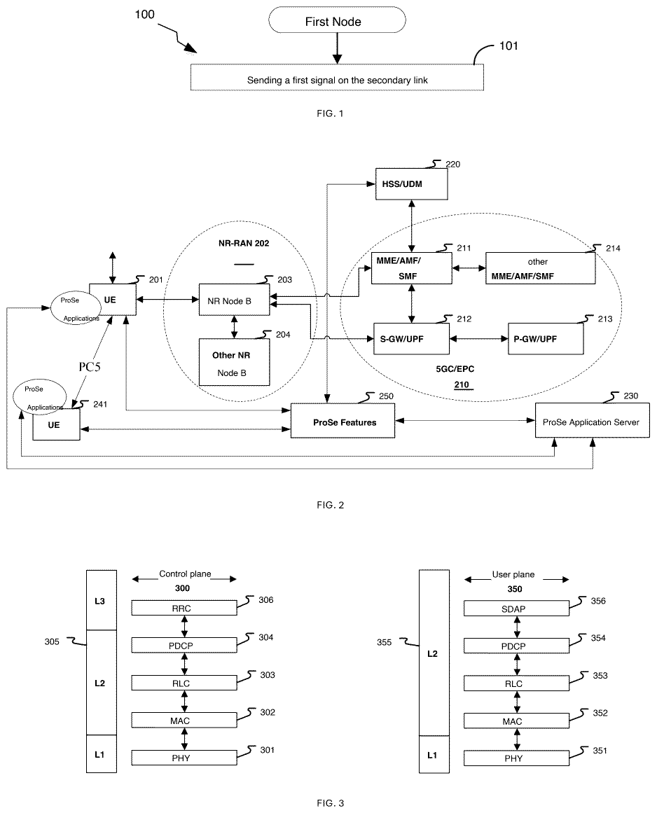

Embodiment 1 illustrates a processing flow chart of a first node of an embodiment of the present application, as shown in FIG. 1. In FIG. 1, one box represents one step.

In Example 1, the first node in the present application executes step 101 to send a first signal on a secondary link, wherein the type of the first signal is used to determine the sending timing of a first time unit, and the first time unit includes the time domain resources occupied by the first signal; the candidates for the type of the first signal include a first type of signal and a second type of signal; the first type of signal includes a reference signal used for secondary link positioning, and the second type of signal is carried on a physical secondary link channel.

As an embodiment, the first type of signal is used for sidelink positioning.

As an embodiment, the first type of signal is used for location related measurement.

As an embodiment, the first type of signal is used for sidelink positioning measurement.

As an embodiment, the first type of signal is used to determine a propagation delay.

As an embodiment, the first type of signal is used to determine RTT (Round Trip Time).

As an embodiment, the first type of signal is used to obtain location information (Location Information).

As an embodiment, the first type of signal is used to obtain a Rx-Tx Time Difference.

As an embodiment, the first type of signal is used to obtain a UE Rx-Tx time difference measurement.

As an embodiment, the first type of signal is used to obtain a sidelink Rx-Tx Time Difference.

As an embodiment, the first type of signal is used to obtain AoA (Angle-of-Arrival).

As an embodiment, the first type of signal is used to obtain a receiving timing (Rx Timing) of the first type of signal.

As an embodiment, the first type of signal is used to obtain the receiving timing of the first time unit.

As an embodiment, the first type of signal is used to obtain RSRP (Reference Signal Received Power).

As an embodiment, the first type of signal is used to obtain RSRPP (Reference Signal Received Path Power).

As an embodiment, the first type of signal is used to obtain RSTD (Reference Signal Time Difference, reference signal time power).

As an embodiment, the first type of signal is used to obtain RTOA (Relative Time of Arrival).

As an embodiment, the first type of signal is used to obtain SL-RTOA.

As an embodiment, the first type of signal is used for RTT positioning.

As an embodiment, the first type of signal is used for Single-sided RTT positioning.

As an embodiment, the first type of signal is used for Double-sided RTT positioning.

As an embodiment, the first type of signal is configured by LMF (Location Management Function).

As an embodiment, the first type of signal is configured by gNB (g-Node-B).

As an embodiment, the first type of signal is configured by the UE.

As an embodiment, the first type of signal includes SL RS (Sidelink Reference Signal, sidelink reference signal).

As an embodiment, the first type of signal includes SL PRS (Sidelink Positioning Reference Signal, sidelink positioning reference signal).

As an embodiment, the first type of signal includes SRS (Sounding Reference Signal, sounding reference signal).

As an embodiment, the first type of signal includes S-PSS (Sidelink Primary Synchronization Signal, secondary link primary synchronization signal).

As an embodiment, the first type of signal includes S-SSS (Sidelink Secondary Synchronization Signal).

As an embodiment, the first type of signal includes PSBCH DMRS (Physical Sidelink Broadcast Channel Demodulation Reference Signal, physical sidelink broadcast channel demodulation reference signal).

As an embodiment, the first type of signal includes S-SS/PSBCH block (Sidelink-Synchronization Signal/PSBCH block, Sidelink-Synchronization Signal/Physical Sidelink Broadcast Channel block).

As an embodiment, the first type of signal includes SL CSI-RS (Sidelink Channel State Information-Reference Signal).

As an embodiment, the first type of signal includes a first type of sequence.

As an embodiment, a first type of sequence is used to generate the first type of signal.

As an embodiment, the first type of sequence is a pseudo-random sequence (Pseudo-Random Sequence).

As an embodiment, the first type of sequence is a low peak to average power ratio sequence (Low-PAPR Sequence, Low-Peak to Average Power Ratio).

As an embodiment, the first type of sequence is a Gold sequence.

As an embodiment, the first type of sequence is an M sequence.

As an embodiment, the first type of sequence is a ZC (Zadeoff-Chu) sequence.

As an embodiment, the first type of sequence is sequentially subjected to sequence generation (Sequence Generation), discrete Fourier transform (Discrete Fourier Transform, DFT), modulation (Modulation) and resource element mapping (Resource Element Mapping), and broadband symbol generation (Generation) to obtain the first type of signal.

As an embodiment, the first type of sequence is sequentially subjected to sequence generation, resource particle mapping, and broadband symbol generation to obtain the first type of signal.

As an embodiment, the first type of sequence is mapped to multiple REs (Resource Elements).

As an embodiment, the second type of signal is used for sidelink communication.

As an embodiment, the second type of signal is used for sidelink transmission.

As an embodiment, the second type of signal includes SL data (secondary link data).

As an embodiment, the second type of signal includes SL-SCH (Secondary Link Shared Channel).

As an embodiment, the second type of signal includes SCI (Sidelink Control Information, sidelink control information).

As an embodiment, the second type of signal includes SL HARQ-ACK (Hybrid Automatic Repeat reQuest-Acknowledgement) information.

As an embodiment, the second type of signal includes conflict information.

As an embodiment, the second type of signal includes SL MIB (Master Information Block).

As an embodiment, the second type of signal includes PSSCH DMRS (Physical Sidelink Shared Channel Demodulation Reference Signal).

As an embodiment, the second type of signal includes PSCCH DMRS (Physical Sidelink Control Channel Demodulation Reference Signal).

As an embodiment, the second type of signal includes S-PSS.

As an embodiment, the second type of signal includes S-SSS.

As an embodiment, the second type of signal includes a first type of bit block, and the first type of bit block includes a positive integer number of bits.

As an embodiment, a first type of bit block is used to generate the second type of signal, and the first type of bit block includes a positive integer number of bits.

As an embodiment, the first type of bit block includes a positive integer number of bits, and all or part of the positive integer number of bits included in the first type of bit block are used to generate the second type of signal.

As an embodiment, the first type of bit block includes 1 CW (Codeword).

As an embodiment, the first type of bit block includes 1 CB (Code Block).

As an embodiment, the first type of bit block includes 1 CBG (Code Block Group).

As an embodiment, the first type of bit block includes 1 TB (Transport Block).

As an embodiment, all or part of the bits of the first type of bit blocks are sequentially subjected to transmission block level CRC (Cyclic Redundancy Check) attachment, code block segmentation, code block level CRC attachment, channel coding, rate matching, code block concatenation, scrambling, modulation, layer mapping, antenna port mapping, mapping to physical resource blocks, baseband signal generation, modulation and upconversion to obtain the second type of signal.

As an embodiment, the second type of signal is the output of the first type of bit block after it passes through a modulation mapper, a layer mapper, precoding, a resource element mapper, and a multi-carrier symbol generation.

As an embodiment, the channel coding is based on polarization code.

As an embodiment, the channel coding is based on LDPC (Low-density Parity-Check) code.

As an embodiment, the second type of signal is carried on a physical secondary link channel.

As an embodiment, the physical sidelink channel includes at least one of PSCCH, PSSCH, PSFCH (Physical Sidelink Feedback Channel) and PSBCH.

As an embodiment, the physical sidelink channel includes PSCCH.

As an embodiment, the physical sidelink channel includes PSSCH.

As an embodiment, the physical sidelink channel includes PSFCH.

As an embodiment, the physical sidelink channel includes PSBCH.

As an embodiment, the candidates for the type of the first signal include the first category signal and the second category signal.

As an embodiment, the type of the first signal is the first category signal, or the second category signal.

As an embodiment, the type of the first signal is the first category signal.

As an embodiment, the type of the first signal is the second type of signal.

As an embodiment, the first signal belongs to the first category of signals.

As an embodiment, the first signal belongs to the second category of signals.

As an embodiment, the first time unit includes time domain resources occupied by the first signal.

As an embodiment, the time-frequency resources occupied by the first signal belong to the first time unit in the time domain.

As an embodiment, the time domain resources occupied by the first signal belong to the first time unit.

As an embodiment, the time-frequency resources occupied by the first signal include multiple REs.

As an embodiment, the time domain resources occupied by the first signal include at least one multi-carrier symbol.

As an embodiment, the time domain resources occupied by the first signal include at least one time slot.

As an embodiment, the first time unit is used by the first node to send the first signal.

As an embodiment, the first time unit is used by the first node for SL sending.

As an embodiment, the first time unit includes a subframe.

As an embodiment, the first time unit includes a sidelink subframe (Sidelink Subframe).

As an embodiment, the first time unit includes an uplink subframe (Uplink Subframe).

As an embodiment, the first time unit includes a subframe, and the subframe includes an uplink symbol (Uplink Symbol).

As an embodiment, the uplink symbol is a multi-carrier symbol.

As an embodiment, the first time unit includes a subframe, and the subframe is used for SL transmission.

As an embodiment, the first time unit includes at least one time slot.

As an embodiment, the first time unit includes at least one sidelink time slot (Sidelink Slot).

As an embodiment, the first time unit includes at least one uplink time slot (Uplink Slot).

As an embodiment, the first time unit includes at least one time slot, and any time slot in the first time unit includes an uplink symbol.

As an embodiment, the first time unit includes at least one time slot, and any time slot within the first time unit is used for SL transmission.

As an embodiment, the multi-carrier symbol is an OFDM (Orthogonal Frequency Division Multiplexing) symbol.

As an embodiment, the multi-carrier symbol is a SC-FDMA (Single-Carrier Frequency Division Multiple Access) symbol.

As an embodiment, the multi-carrier symbol is a DFT-S-OFDM (Discrete Fourier Transform Spread Orthogonal Frequency Division Multiplexing) symbol.

As an embodiment, the multi-carrier symbol is an IFDMA (Interleaved Frequency Division Multiple Access) symbol.

As an embodiment, the sending timing of the first time unit is the first sending timing, or the sending timing of the first time unit is the uplink sending timing of the first node.

As an embodiment, the sending timing of the first time unit is related to the type of the first signal.

As an embodiment, the sending timing of the first time unit is related to whether the type of the first signal is the first category signal.

As an embodiment, the sending timing of the first time unit is related to whether the type of the first signal is the second type of signal.

As an embodiment, the sending timing of the first time unit is related to the positional relationship between the time domain resources occupied by the first signal and the first time window.

As an embodiment, the positional relationship between the time domain resources occupied by the first signal and the first time window includes that the time domain resources occupied by the first signal are within the first time window, or that the time domain resources occupied by the first signal are outside the first time window.

As an embodiment, the sending timing of the first time unit is related to whether the time domain resources occupied by the first signal are within the first time window.

As an embodiment, the sending timing of the first time unit is related to whether the time domain resources occupied by the first signal are outside the first time window.

As an embodiment, the sending timing of the first time unit is related to the type of the first signal and the positional relationship between the time domain resources occupied by the first signal and the first time window.

As an embodiment, the type of the first signal is used to determine the sending timing of the first time unit.

As an embodiment, the type of the first signal and the positional relationship between the time domain resources occupied by the first signal and the first time window are used to determine the sending timing of the first time unit.

As an embodiment, the type of the first signal is the second type of signal, and the sending timing of the first time unit is the uplink sending timing of the first node.

As an embodiment, the type of the first signal is the first category signal, the time domain resources occupied by the first signal are within the first time window, and the sending timing of the first time unit is the first sending timing.

As an embodiment, the type of the first signal is the first category signal, the time domain resources occupied by the first signal are outside the first time window, and the sending timing of the first time unit is the uplink sending timing of the first node.

As an embodiment, when the type of the first signal is the first category signal, whether the time domain resources occupied by the first signal are used within a first time window to determine the sending timing of the first time unit.

As an embodiment, when the type of the first signal is the second type of signal, the sending timing of the first time unit is the uplink sending timing of the first node.

As an embodiment, the type of the first signal is the first type of signal; when the time domain resources occupied by the first signal are within the first time window, the sending timing of the first time unit is the first sending timing; when the time domain resources occupied by the first signal are outside the first time window, the sending timing of the first time unit is the uplink sending timing of the first node.

As an embodiment, when the type of the first signal is the first category signal, the positional relationship between the time domain resources occupied by the first signal and the first time window is used to determine the sending timing of the first time unit; when the type of the first signal is the second category signal, the sending timing of the first time unit is the uplink sending timing of the first node.

As an embodiment, when the type of the first signal is the first category signal, the positional relationship between the time domain resources occupied by the first signal and the first time window is used to determine whether the sending timing of the first time unit is the first sending timing or the uplink sending timing of the first node; when the type of the first signal is the second category signal, the sending timing of the first time unit is the uplink sending timing of the first node.

As an embodiment, when the type of the first signal is the first category signal and the time domain resources occupied by the first signal are within the first time window, the sending timing of the first time unit is the first sending timing; when the type of the first signal is the first category signal and the time domain resources occupied by the first signal are outside the first time window, the sending timing of the first time unit is the uplink sending timing of the first node; when the type of the first signal is the second category signal, the sending timing of the first time unit is the uplink sending timing of the first node.

As an embodiment, the first time window includes the first time unit.

As an embodiment, the first time window does not include the first time unit.

As an embodiment, the first time window is related to a sending period of the first signal.

As an embodiment, the length of the first time window is the sending period of the first signal.

As an embodiment, the length of the first time window is a multiple of the sending period of the first signal.

As an embodiment, the first time window is the effective time period of the first sending timing.

As an embodiment, the first time window includes one or more subframes.

As an embodiment, the first time window includes one or more side link subframes.

As an embodiment, the first time window includes one or more uplink subframes.

As an embodiment, the first time window includes one or more time slots.

As an embodiment, the first time window includes one or more secondary link time slots.

As an embodiment, the first time window includes one or more uplink time slots.

As an embodiment, the first time window is configured by higher layer signaling.

As an embodiment, the first time window is LMF configured.

As an embodiment, the first time window is configured by the gNB.

As an embodiment, the first time window is configured by the UE.

As an embodiment, the first sending timing is determined by the first node itself.

As an embodiment, the first sending timing is the same as the downlink receiving timing of the first node.

As an embodiment, the first sending timing is the timing of the first node receiving a downlink signal.

As an embodiment, the first sending timing is the timing at which the first node performs downlink reception.

As an embodiment, the downlink signal includes a SS/PBCH block (Synchronization Signal/Physical Broadcast Channel block).

As an embodiment, the downlink signal includes a PSS (Primary Synchronization Signal).

As an embodiment, the downlink signal includes SSS (Secondary Synchronization Signal).

As an embodiment, the downlink signal includes CSI-RS.

As an embodiment, the downlink signal includes a DL PRS (Downlink Positioning Reference Signal, downlink positioning reference signal).

As an embodiment, the downlink signal includes DCI (Downlink Control Information, downlink control information).

As an embodiment, the downlink signal includes a signal received on a PDSCH.

As an embodiment, the first sending timing is based on GNSS (Global Navigation Satellite System) timing.

As an embodiment, the first sending timing is based on the timing of an RSU.

As an embodiment, the first sending timing is based on the timing of S-SS/PSBCH sent by a UE.

As an embodiment, the first sending timing is based on the timing of a synchronization reference source (SyncRef Source) of the first node.

As an embodiment, the first sending timing remains unchanged within the first time window.

As an embodiment, all transmissions within the first time window are the first transmission timing.

As an embodiment, the transmission timing on any subframe within the first time window is the first transmission timing.

As an embodiment, the transmission timing at any time slot within the first time window is the first transmission timing.

As an embodiment, the transmission timing on any multi-carrier symbol within the first time window is the first transmission timing.

As an embodiment, the uplink transmission timing of the first node depends on a first timing reference radio frame.

As an embodiment, the uplink sending timing of the first node is the timing of the first node sending an uplink signal.

As an embodiment, the uplink sending timing of the first node is the timing of the first node performing uplink sending.

As an embodiment, the uplink signal includes a signal sent on a PUSCH (Physical Uplink Shared Channel).

As an embodiment, the uplink signal includes UCI (Uplink Control Information, uplink control information).

As an embodiment, the uplink signal includes an SRS (Sounding Reference Signal).

As an embodiment, the first timing reference radio frame is a first downlink radio frame, and the first downlink radio frame is a downlink radio frame of a service cell to which the first node belongs.

As an embodiment, the uplink transmission timing of the first node is (N_{TA,SL}+N_{TA,offset})·T_{c} seconds before the start of the first timing reference radio frame, and T_{c} is 1/(480000×4096) seconds.

As an embodiment, the above N_{TA,SL} and the above N_{TA,offset} may refer to section 8.5 of TS 38.211.

As an embodiment, the first signal occupies at least one multi-carrier symbol in the time domain, and the first signal occupies at least one subcarrier in the frequency domain.

As an embodiment, the time domain resources occupied by the first signal belong to a time slot, and the frequency domain resources occupied by the first signal spans a PRB (Physical Resource Block).

As an embodiment, the time domain resources occupied by the first signal belong to a time slot, and the frequency domain resources occupied by the first signal belong to a Subchannel.

### EXAMPLE 2

Embodiment 2 illustrates a schematic diagram of a network architecture according to an embodiment of the present application, as shown in FIG. 2. FIG. 2 illustrates the V2X communication architecture under the 5G NR (New Radio), LTE (Long-Term Evolution) and LTE-A (Long-Term Evolution Advanced) system architecture. The 5G NR or LTE network architecture may be referred to as 5GS (5G System)/EPS (Evolved Packet System) or some other suitable term.

The V2X communication architecture of embodiment 2 includes UE201, UE241, NG-RAN (next generation radio access network) 202, 5GC (5G Core Network)/EPC (Evolved Packet Core) 210, HSS (Home Subscriber Server)/UDM (Unified Data Management) 220, ProSe function 250 and ProSe application server 230. The V2X communication architecture can be interconnected with other access networks, but these entities/interfaces are not shown for simplicity. As shown, the V2X communication architecture provides packet switching services, but it will be easy for technicians in the field to understand that the various concepts presented throughout this application can be extended to networks that provide circuit switching services or other cellular networks. NG-RAN includes NR Node B (gNB) 203 and other gNBs 204. gNB 203 provides user and control plane protocol termination towards UE 201. gNB 203 can be connected to other gNBs 204 via an Xn interface (e.g., backhaul). The gNB 203 may also be referred to as a base station, a base transceiver station, a radio base station, a radio transceiver, a transceiver function, a basic service set (BSS), an extended service set (ESS), a transmit receive node (TRP), or some other suitable term. The gNB 203 provides an access point to the 5GC/EPC 210 for the UE 201. Examples of UE 201 include a cellular phone, a smart phone, a session initiation protocol (SIP) phone, a laptop computer, a personal digital assistant (PDA), a satellite radio, non-terrestrial base station communications, satellite mobile communications, a global positioning system, a multimedia device, a video device, a digital audio player (e.g., an MP3 player), a camera, a game console, a drone, an aircraft, a narrowband Internet of Things device, a machine type communication device, a land vehicle, an automobile, a wearable device, or any other similar functional device. A person skilled in the art may also refer to UE201 as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term. The gNB203 is connected to the 5GC/EPC210 via an S1/NG interface. The 5GC/EPC210 includes an MME (Mobility Management Entity)/AMF (Authentication Management Field)/SMF (Session Management Function) 211, other MME/AMF/SMF214, an S-GW (Service Gateway)/UPF (User Plane Function) 212, and a P-GW (Packet Data Network Gateway)/UPF213. MME/AMF/SMF211 is the control node that handles the signaling between UE201 and 5GC/EPC210. In general, MME/AMF/SMF211 provides bearer and connection management. All user IP (Internet Protocol) packets are transmitted through S-GW/UPF212, which itself is connected to P-GW/UPF213. P-GW provides UE IP address allocation and other functions. P-GW/UPF213 is connected to Internet services 230. Internet services 230 include operator-corresponding Internet protocol services, which may specifically include Internet, intranet, IMS (IP Multimedia Subsystem) and packet-switched streaming services. The ProSe function 250 is a logical function for network-related behaviors required for ProSe (Proximity-based Service), including DPF (Direct Provisioning Function), Direct Discovery Name Management Function, EPC-level Discovery ProSe Function, etc. The ProSe application server 230 has functions such as storing EPC ProSe user identities, mapping between application layer user identities and EPC ProSe user identities, and allocating ProSe restricted code suffix pools.

As an embodiment, the UE 201 and the UE 241 are connected via a PC5 reference point (Reference Point).

As an embodiment, the ProSe function 250 is connected to the UE 201 and the UE 241 via a PC3 reference point respectively.

As an embodiment, the ProSe function 250 is connected to the ProSe application server 230 via a PC2 reference point.

As an embodiment, the ProSe application server 230 is connected to the ProSe application of the UE 201 and the ProSe application of the UE 241 through a PC1 reference point respectively.

As an embodiment, the first node in the present application is the UE 201, and the second node in the present application is the UE 241.

As an embodiment, the first node in the present application is the UE 241, and the second node in the present application is the UE 201.

As an embodiment, the sender of the first signal in the present application is the UE 201.

As an embodiment, the receiver of the first signal in the present application is the UE 241.

As an embodiment, the sender of the first signal in the present application is the UE 241.

As an embodiment, the receiver of the first signal in the present application is the UE 201.

As an embodiment, the wireless link between the UE 201 and the UE 241 corresponds to the side link (Sidelink, SL) in this application.

As an embodiment, the wireless link from the UE 201 to the NR Node B is an uplink.

As an embodiment, the wireless link from the NR Node B to UE 201 is a downlink.

As an embodiment, the UE 201 supports SL transmission.

As an embodiment, the UE 241 supports SL transmission.

As an embodiment, the gNB 203 is a macrocellular base station.

As an embodiment, the gNB 203 is a microcell base station.

As an embodiment, the gNB 203 is a picoCell base station.

As an embodiment, the gNB 203 is a home base station (Femtocell).

As an embodiment, the gNB 203 is a base station device that supports large delay difference.

As an embodiment, the gNB 203 is an RSU.

As an embodiment, the gNB 203 includes a satellite device.

### EXAMPLE 3

Embodiment 3 shows a schematic diagram of an embodiment of a wireless protocol architecture of a user plane and a control plane according to the present application, as shown in FIG. 3. FIG. 3 is a schematic diagram illustrating an embodiment of a radio protocol architecture for a user plane 350 and a control plane 300. FIG. 3 shows the radio protocol architecture of the control plane 300 for a first node device (RSU in UE or V2X, vehicle-mounted device or vehicle-mounted communication module) and a second node device (gNB, RSU in UE or V2X, vehicle-mounted device or vehicle-mounted communication module), or between two UEs using three layers: Layer 1, Layer 2, and Layer 3. Layer 1 (L1 layer) is the lowest layer and implements various PHY (physical layer) signal processing functions. The L1 layer will be referred to as PHY301 herein. Layer 2 (L2 layer) 305 is above PHY301 and is responsible for the link between the first node device and the second node device and the two UEs through PHY301. The L2 layer 305 includes a MAC (Medium Access Control) sublayer 302, an RLC (Radio Link Control) sublayer 303, and a PDCP (Packet Data Convergence Protocol) sublayer 304, which terminate at the second node device. The PDCP sublayer 304 provides data encryption and integrity protection, and also provides inter-zone mobility support for the first node device to the second node device. The RLC sublayer 303 provides segmentation and reassembly of data packets, and retransmission of lost data packets through ARQ. The RLC sublayer 303 also provides duplicate data packet detection and protocol error detection. The MAC sublayer 302 provides mapping between logical and transport channels and multiplexing of logical channels. The MAC sublayer 302 is also responsible for allocating various radio resources (e.g., resource blocks) in a cell between the first node devices. The MAC sublayer 302 is also responsible for HARQ (Hybrid Automatic Repeat reQuest) operations. The RRC (Radio Resource Control) sublayer 306 in layer 3 (L3 layer) in the control plane 300 is responsible for obtaining radio resources (i.e., radio bearers) and configuring the lower layer using RRC signaling between the second node device and the first node device. The radio protocol architecture of the user plane 350 includes layer 1 (L1 layer) and layer 2 (L2 layer). The radio protocol architecture for the first node device and the second node device in the user plane 350 is substantially the same as the corresponding layers and sublayers in the control plane 300 for the physical layer 351, the PDCP sublayer 354 in the L2 layer 355, the RLC sublayer 353 in the L2 layer 355, and the MAC sublayer 352 in the L2 layer 355, but the PDCP sublayer 354 also provides header compression for upper layer data packets to reduce wireless transmission overhead. The L2 layer 355 in the user plane 350 also includes a SDAP (Service Data Adaptation Protocol) sublayer 356, which is responsible for mapping between QoS flows and data radio bearers (DRBs) to support the diversity of services. Although not shown, the first node device may have several upper layers above the L2 layer 355, including a network layer (e.g., an IP layer) terminated at the P-GW on the network side and an application layer terminated at the other end of the connection (e.g., a remote UE, a server, etc.).

As an embodiment, the wireless protocol architecture in FIG. 3 is applicable to the first node in the present application.

As an embodiment, the wireless protocol architecture in FIG. 3 is applicable to the second node in the present application.

As an embodiment, the first signal in the present application is generated by the PHY301.

As an embodiment, the first signal in the present application is generated in the MAC sublayer 302.

As an embodiment, the first signal in the present application is generated in the RRC sublayer 306.

### EXAMPLE 4

Embodiment 4 shows a schematic diagram of a first communication device and a second communication device according to an embodiment of the present application, as shown in FIG. 4. FIG. 4 is a block diagram of a first communication device 410 and a second communication device 450 communicating with each other in an access network.

The first communication device 410 includes a controller/processor 475, a memory 476, a receive processor 470, a transmit processor 416, a multi-antenna receive processor 472, a multi-antenna transmit processor 471, a transmitter/receiver 418 and an antenna 420.

The second communication device 450 includes a controller/processor 459, a memory 460, a data source 467, a transmit processor 468, a receive processor 456, a multi-antenna transmit processor 457, a multi-antenna receive processor 458, a transmitter/receiver 454 and an antenna 452.

In transmission from the first communication device 410 to the second communication device 450, at the first communication device 410, upper layer data packets from the core network are provided to the controller/processor 475. The controller/processor 475 implements the functionality of the L2 layer. In transmission from the first communication device 410 to the first communication device 450, the controller/processor 475 provides header compression, encryption, packet segmentation and reordering, multiplexing between logical and transport channels, and radio resource allocation to the second communication device 450 based on various priority metrics. The controller/processor 475 is also responsible for retransmission of lost packets and signaling to the second communication device 450. The transmit processor 416 and the multi-antenna transmit processor 471 implement various signal processing functions for the L1 layer (i.e., the physical layer). The transmit processor 416 implements coding and interleaving to facilitate forward error correction (FEC) at the second communication device 450, as well as mapping of signal constellations based on various modulation schemes (e.g., binary phase shift keying (BPSK), quadrature phase shift keying (QPSK), M-phase shift keying (M-PSK), M-quadrature amplitude modulation (M-QAM)). The multi-antenna transmit processor 471 performs digital spatial precoding, including codebook-based precoding and non-codebook-based precoding, and beamforming processing on the coded and modulated symbols to generate one or more spatial streams. The transmit processor 416 then maps each spatial stream to a subcarrier, multiplexes with a reference signal (e.g., a pilot) in the time domain and/or frequency domain, and then uses an inverse fast Fourier transform (IFFT) to generate a physical channel carrying a time-domain multi-carrier symbol stream. The multi-antenna transmit processor 471 then performs a transmit analog precoding/beamforming operation on the time-domain multi-carrier symbol stream. Each transmitter 418 converts the baseband multi-carrier symbol stream provided by the multi-antenna transmit processor 471 into a radio frequency stream, and then provides it to a different antenna 420.

In the transmission from the first communication device 410 to the second communication device 450, at the second communication device 450, each receiver 454 receives a signal through its corresponding antenna 452. Each receiver 454 recovers the information modulated onto the RF carrier and converts the RF stream into a baseband multi-carrier symbol stream and provides it to the receiving processor 456. The receiving processor 456 and the multi-antenna receiving processor 458 implement various signal processing functions of the L1 layer. The multi-antenna receiving processor 458 performs a receiving analog precoding/beamforming operation on the baseband multi-carrier symbol stream from the receiver 454. The receiving processor 456 uses a fast Fourier transform (FFT) to convert the baseband multi-carrier symbol stream after the receiving analog precoding/beamforming operation from the time domain to the frequency domain. In the frequency domain, the physical layer data signal and the reference signal are demultiplexed by the receiving processor 456, wherein the reference signal will be used for channel estimation, and the data signal is recovered after multi-antenna detection in the multi-antenna receiving processor 458 to any spatial stream destined for the second communication device 450. The symbols on each spatial stream are demodulated and recovered in the receive processor 456, and soft decisions are generated. The receive processor 456 then decodes and deinterleaves the soft decisions to recover the upper layer data and control signals transmitted by the first communication device 410 on the physical channel. The upper layer data and control signals are then provided to the controller/processor 459. The controller/processor 459 implements the functions of the L2 layer. The controller/processor 459 may be associated with a memory 460 that stores program codes and data. The memory 460 may be referred to as a computer-readable medium. In the transmission from the first communication device 410 to the second communication device 450, the controller/processor 459 provides multiplexing between transport and logical channels, packet reassembly, decryption, header decompression, control signal processing to recover the upper layer data packets from the core network. The upper layer data packets are then provided to all protocol layers above the L2 layer. Various control signals may also be provided to the L3 for L3 processing.

In the transmission from the second communication device 450 to the first communication device 410, at the second communication device 450, a data source 467 is used to provide upper layer data packets to the controller/processor 459. The data source 467 represents all protocol layers above the L2 layer. Similar to the transmission function at the first communication device 410 described in the transmission from the first communication device 410 to the second communication device 450, the controller/processor 459 implements header compression, encryption, packet segmentation and reordering, and multiplexing between logical and transport channels based on radio resource allocation, and implements L2 layer functions for user plane and control plane. The controller/processor 459 is also responsible for the retransmission of lost packets and signaling to the first communication device 410. The transmit processor 468 performs modulation mapping and channel coding processing, and the multi-antenna transmit processor 457 performs digital multi-antenna spatial precoding, including codebook-based precoding and non-codebook-based precoding, and beamforming processing. Then, the transmit processor 468 modulates the generated spatial stream into a multi-carrier/single-carrier symbol stream, which is then provided to different antennas 452 via the transmitter 454 after analog precoding/beamforming operations in the multi-antenna transmit processor 457. Each transmitter 454 first converts the baseband symbol stream provided by the multi-antenna transmit processor 457 into a radio frequency symbol stream, and then provides it to the antenna 452.

In the transmission from the second communication device 450 to the first communication device 410, the functions at the first communication device 410 are similar to the reception functions at the second communication device 450 described in the transmission from the first communication device 410 to the second communication device 450. Each receiver 418 receives a radio frequency signal through its corresponding antenna 420, converts the received radio frequency signal into a baseband signal, and provides the baseband signal to the multi-antenna reception processor 472 and the reception processor 470. The reception processor 470 and the multi-antenna reception processor 472 jointly implement the functions of the L1 layer. The controller/processor 475 implements the L2 layer functions. The controller/processor 475 can be associated with a memory 476 that stores program codes and data. The memory 476 can be referred to as a computer-readable medium. In the transmission from the second communication device 450 to the first communication device 410, the controller/processor 475 provides demultiplexing between transport and logical channels, packet reassembly, decryption, header decompression, control signal processing to recover the upper layer data packets from the UE 450. Upper layer packets from the controller/processor 475 may be provided to the core network.

As an embodiment, the second communication device 450 includes: at least one processor and at least one memory, the at least one memory includes computer program code; the at least one memory and the computer program code are configured to be used together with the at least one processor. The second communication device 450 device at least: sends a first signal on a secondary link; wherein the type of the first signal is used to determine the sending timing of a first time unit, the first time unit includes the time domain resources occupied by the first signal; the candidates for the type of the first signal include a first type of signal and a second type of signal; the first type of signal includes a reference signal used for secondary link positioning, and the second type of signal is carried on a physical secondary link channel.

As an embodiment, the second communication device 450 includes: a memory storing a computer-readable instruction program, wherein the computer-readable instruction program generates an action when executed by at least one processor, and the action includes: sending a first signal on a secondary link; wherein the type of the first signal is used to determine the sending timing of a first time unit, and the first time unit includes the time domain resources occupied by the first signal; the candidates for the type of the first signal include a first type of signal and a second type of signal; the first type of signal includes a reference signal used for secondary link positioning, and the second type of signal is carried on a physical secondary link channel.

As an embodiment, the first communication device 410 includes: at least one processor and at least one memory, the at least one memory includes computer program code; the at least one memory and the computer program code are configured to be used together with the at least one processor. The first communication device 410 device at least: receives a first signal on a secondary link; wherein the type of the first signal is used to determine the transmission timing of a first time unit, the first time unit includes the time domain resources occupied by the first signal; the candidates for the type of the first signal include a first type of signal and a second type of signal; the first type of signal includes a reference signal used for secondary link positioning, and the second type of signal is carried on a physical secondary link channel.

As an embodiment, the first communication device 410 includes: a memory storing a computer-readable instruction program, wherein the computer-readable instruction program generates an action when executed by at least one processor, and the action includes: receiving a first signal on a secondary link; wherein the type of the first signal is used to determine the sending timing of a first time unit, and the first time unit includes the time domain resources occupied by the first signal; the candidates for the type of the first signal include a first type of signal and a second type of signal; the first type of signal includes a reference signal used for secondary link positioning, and the second type of signal is carried on a physical secondary link channel.

As an embodiment, the second communication device 450 corresponds to the first node in this application.

As an embodiment, the first communication device 410 corresponds to the second node in this application.

As an embodiment, the second communication device 450 is a UE.

As an embodiment, the first communication device 410 is a UE.

As an embodiment, at least one of the antenna 452, the transmitter 454, the multi-antenna transmit processor 457, the transmit processor 468, the controller/processor 459, the memory 460, and the data source 467 is used to send the first signal in the present application.

As an embodiment, at least one of the antenna 420, the receiver 418, the multi-antenna reception processor 472, the reception processor 470, the controller/processor 475, and the memory 476 is used to receive the first signal in the present application.

### EXAMPLE 5

Embodiment 5 illustrates a structural diagram of UE positioning according to an embodiment of the present application, as shown in FIG. 5.

UE 501 communicates with UE 502 via PC5 interface; UE 502 communicates with ng-eNB 503 or gNB 504 via LTE-Uu interface or NR-Uu new radio interface; ng-eNB50 3 and gNB 504 are sometimes referred to as base stations, and ng-eNB 503 and gNB 50 4 are also referred to as NG (Next Generation)-RAN (Radio Access Network). ng-eNB 503 and gNB 504 are connected to AMF (Authentication Management Field) 505 via NG (Next Generation)-C (Control plane); AMF 505 is connected to LMF (Location Management Function) 506 via NL1 interface.

The AMF 505 receives a location service request associated with a specific UE from another entity, such as a GMLC (Gateway Mobile Location Centre) or a UE, or the AMF 505 decides to start the location service associated with the specific UE; then the AMF 505 sends the location service request to an LMF, such as the LMF 506; then the LMF processes the location service request, including sending auxiliary data to the specific UE to assist UE-based or UE-assisted positioning, and including receiving location information reported by the UE; then the LMF returns the result of the location service to the AMF 505; if the location service is requested by another entity, the AMF 505 returns the result of the location service to that entity.

As an embodiment, the network device of the present application includes LMF.

As an embodiment, the network equipment of the present application includes NG-RAN and LMF.

As an embodiment, the network equipment of the present application includes NG-RAN, AMF and LMF.

### EXAMPLE 6

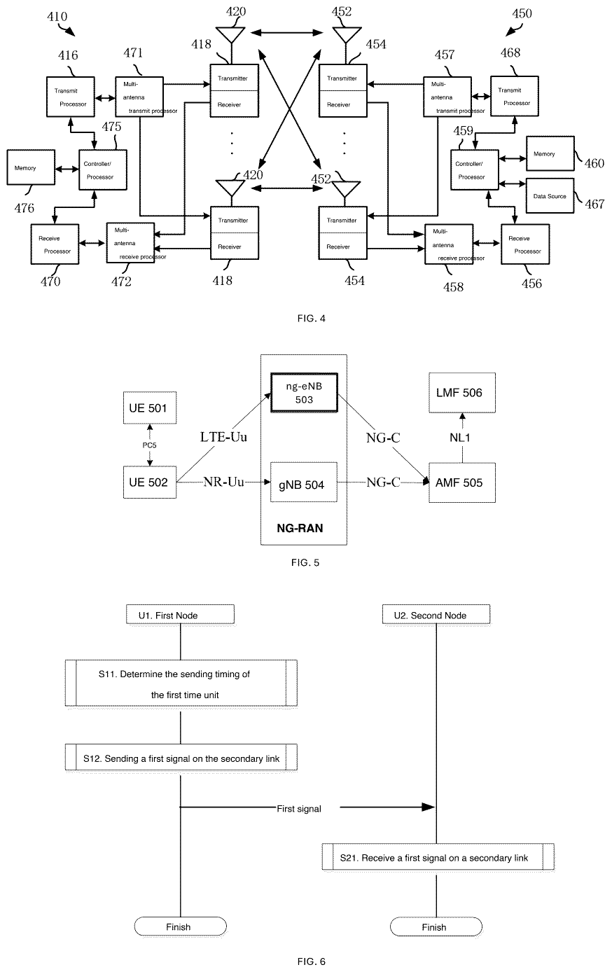

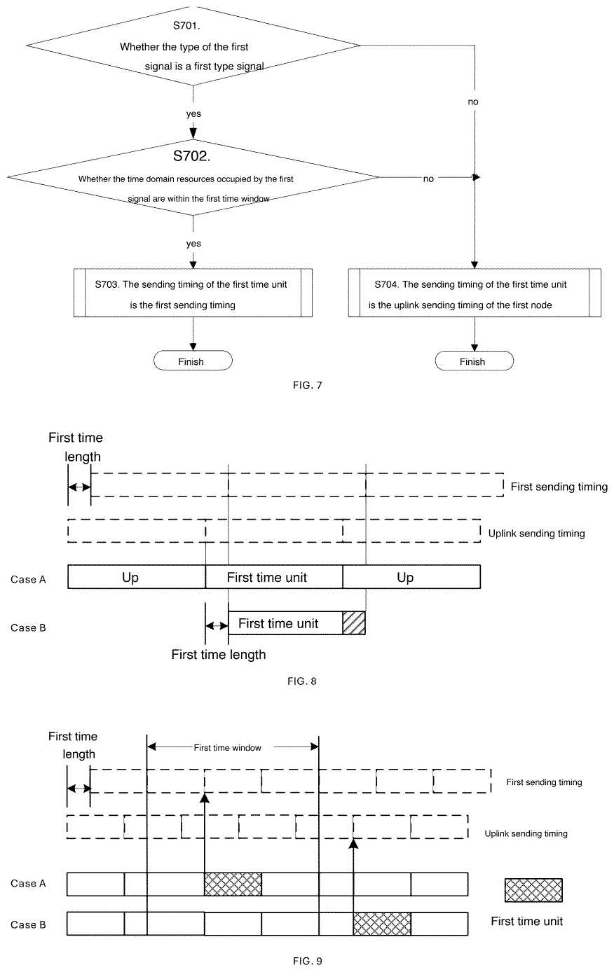

Embodiment 6 illustrates a wireless signal transmission flow chart according to an embodiment of the present application, as shown in FIG. 6. In FIG. 6, the first node U1 and the second node U2 communicate with each other through an air interface.

For the first node U1, the sending timing of the first time unit is determined in step S11; and the first signal is sent on the secondary link in step S12.

For the second node U2, a first signal is received on the secondary link in step S21.

In embodiment 6, the type of the first signal is used to determine the sending timing of the first time unit, and the first time unit includes the time domain resources occupied by the first signal; the candidates for the type of the first signal include first type signals and second type signals; the first type signal includes a reference signal used for sub-link positioning, and the second type signal is carried on a physical sub-link channel; when the type of the first signal is the first type signal, whether the time domain resources occupied by the first signal are within the first time window is used to determine the sending timing of the first time unit; when the time domain resources occupied by the first signal are within the first time window, the sending timing of the first time unit is the first sending timing; when the time domain resources occupied by the first signal are outside the first time window, the sending timing of the first time unit is the uplink sending timing of the first node; when the type of the first signal is the second type signal, the sending timing of the first time unit is the uplink sending timing of the first node; multiple first type signals sent by the first node in the first time window all adopt the first sending timing; the first sending timing remains unchanged within the first time window.

As an embodiment, the first sending timing is determined by the first node itself.

As an embodiment, the first sending timing is a downlink receiving timing.

As an embodiment, the first sending timing is based on GNSS timing.

As an embodiment, the first sending timing is based on the timing of an RSU.

As an embodiment, the first sending timing is based on the timing of S-SS/PSBCH sent by a UE.

As an embodiment, the above steps are beneficial for the first node U1 to flexibly adjust the sending timing.

As an embodiment, the above steps are helpful to reduce the complexity of adjusting the sending timing of the first node U1.

As an embodiment, the first node U1 and the second node U2 communicate with each other through a PC5 interface.

As an embodiment, the first node U 1 sends the first signal to the second node U 2.

As an embodiment, the second node U 2 receives the first signal from the first node U 1.

As an embodiment, the first node U1 determines the sending timing of the first time unit according to the type of the first signal.

As an embodiment, when the type of the first signal is the first category signal, the first node U1 determines the sending timing of the first time unit according to whether the time domain resources occupied by the first signal are within the first time window.

### EXAMPLE 7

Embodiment 7 illustrates a flowchart of determining the sending timing of the first time unit according to an embodiment of the present application, as shown in FIG. 7.

In Example 7, in step S701, it is determined whether the type of the first signal is a first type of signal; when the type of the first signal is not a first type of signal, step S704 is executed to determine that the sending timing of the first time unit is the uplink sending timing of the first node; when the type of the first signal is a first type of signal, step S702 is executed to determine whether the time domain resources occupied by the first signal are within the first time window; when the time domain resources occupied by the first signal are not within the first time window, step S704 is executed to determine that the sending timing of the first time unit is the uplink sending timing of the first node; when the time domain resources occupied by the first signal are within the first time window, step S703 is executed to determine that the sending timing of the first time unit is the first sending timing.

As an embodiment, the first type of signal includes SL RS.

As an embodiment, the first type of signal includes SL PRS.

As an embodiment, the first type of signal includes SRS.

As an embodiment, the first type of signal includes S-PSS.

As an embodiment, the first type of signal includes S-SSS.

As an embodiment, the first type of signal includes PSBCH.

As an embodiment, the first type of signal includes S-SS/PSBCH block.

As an embodiment, the second type of signal includes SL data.

As an embodiment, the second type of signal includes SL-SCH.

As an embodiment, the second type of signal includes SCI.

As an embodiment, the second type of signal includes SL HARQ-ACK information.

As an embodiment, the second type of signal includes SL MIB.

As an embodiment, the second type of signal is carried on a physical secondary link channel.

As an embodiment, the candidates for the type of the first signal are the first category signal and the second category signal.

As an embodiment, the type of the first signal is one of the first type of signal and the second type of signal.

As an embodiment, when the type of the first signal is the second type of signal, the sending timing of the first time unit adopts the uplink sending timing of the first node.

As an embodiment, when the type of the first signal is the first category signal and the time domain resources occupied by the first signal are not within the first time window, the sending timing of the first time unit adopts the uplink sending timing of the first node.

As an embodiment, when the type of the first signal is the first category signal and the time domain resources occupied by the first signal are within the first time window, the sending timing of the first time unit adopts the first sending timing.

As an embodiment, the first time window includes a first time unit.

As an embodiment, the first time window does not include a first time unit.

As an embodiment, the first time window is related to a period of the first signal.

As an embodiment, the first time window is the effective time period of the first sending timing.

As an embodiment, the first time window includes one or more subframes.

As an embodiment, the first time window includes one or more secondary link subframes.

As an embodiment, the first time window includes one or more uplink subframes.

As an embodiment, the first time window includes one or more time slots.

As an embodiment, the first time window includes one or more secondary link time slots.

As an embodiment, the first time window includes one or more uplink time slots.

### EXAMPLE 8

Embodiment 8 illustrates a schematic diagram of the relationship between the first sending timing and the uplink sending timing according to an embodiment of the present application, as shown in FIG. 8.

In Example 8, there is an offset value of a first time length between the first sending timing and the uplink sending timing; in case A, the sending timing of the first time unit is the uplink sending timing of the first node; in case B, the sending timing of the first time unit is the first sending timing.

As an embodiment, the situation A includes that the type of the first signal is a second type signal.

As an embodiment, the situation A includes that the type of the first signal is a first category signal, and the time domain resources occupied by the first signal are outside a first time window.

As an embodiment, the situation B includes that the type of the first signal is the first category signal, and the time domain resources occupied by the first signal are within the first time window.

As an embodiment, the first time unit is used to send a first signal.

As an embodiment, the first time unit is used by the first node for SL sending.

As an embodiment, the sending timing of the first time unit is the start of the first time unit.

As an embodiment, the uplink sending timing is related to the first time length.

As an embodiment, the first time length is a timing advance (Timing Advance).

As an embodiment, the first time length is one of multiple time lengths.

As an embodiment, the index of the first time length is used to indicate the position of the first time length among the multiple time lengths.

As an embodiment, the index of the first time length is used to indicate the first time length from among the multiple time lengths.

As an embodiment, the index of the first time length is one of T consecutive non-negative integers starting from 0, and T is a positive integer greater than 1.

As an embodiment, the index of the first time length is one of 3847 consecutive non-negative integers from 0 to 3846.

As an embodiment, the index of the first time length is one of 64 consecutive non-negative integers from 0 to 63.

As an embodiment, the first time length is related to the subcarrier spacing of the frequency domain resources occupied by the first signal.

As an embodiment, the resolution of the first time length is T_{c} and T_{c} is 1/(480000×4096) seconds.

As an embodiment, the resolution of the first time length is a positive integer multiple of T_{c}, and T_{c} is 1/(480000×4096) seconds.

As an embodiment, the first time length is equal to (T_{A}·16·64/2^{μ})·T_{c}, μ is a non-negative integer, T_{A} is the index of the first time length, and T_{c} is 1/(480000×4096) seconds.

As an embodiment, μ is related to the subcarrier spacing of the frequency domain resources occupied by the first signal.

As an embodiment, the subcarrier spacing of the frequency domain resources occupied by the first signal is 2^{μ}×15 kHz.

As an embodiment, μ is one of {0, 1, 2, 3, 4, 5, 6}.

As an embodiment, the first time length is related to a second time length, and the second time length is a time length before sending the first signal.

As an embodiment, the second time length is a timing advance.

As an embodiment, the second time length is one of the multiple time lengths.

As an embodiment, the first time length is equal to the second time length plus ((T_{A}−31)·16·64/2^{μ})·T_{c}, μ is a non-negative integer, T_{A} is the index of the first time length, and T_{c} is 1/(480000×4096) seconds.

As an embodiment, the unit of the first time length is s (seconds).

As an embodiment, the unit of the second time length is s (seconds).

As an embodiment, the unit of the first time length is ms (milliseconds).

As an embodiment, the unit of the second time length is ms (milliseconds).

### EXAMPLE 9

Embodiment 9 illustrates a schematic diagram of a first time window according to an embodiment of the present application, as shown in FIG. 9.

In Example 9, in case A, the first time unit is within the first time window, and the sending timing of the first time unit is the first sending timing; in case B, the first time unit is outside the first time window, and the sending timing of the first time unit is the uplink sending timing of the first node.

As an embodiment, there is an offset value of a first time length between the first sending timing and the uplink sending timing.

As an embodiment, case A includes that the type of the first signal is a first category signal, and the time domain resources occupied by the first signal are within the first time window.

As an embodiment, case B includes that the type of the first signal is the first category signal, and the time domain resources occupied by the first signal are outside the first time window.

As an embodiment, in case A, the sending timing of the first time unit is the first sending timing.

As an embodiment, in case B, the sending timing of the first time unit is the uplink sending timing of the first node.

As an embodiment, the first time window includes a first time unit.

As an embodiment, the first time window does not include a first time unit.

As an embodiment, the first time window includes one or more of the first type of signals.

As an embodiment, the first time window does not include the first type of signal.

As an embodiment, a plurality of first-type signals sent by the first node in the first time window all adopt the first sending timing.

As an embodiment, the first sending timing remains unchanged within the first time window.

### EXAMPLE 10

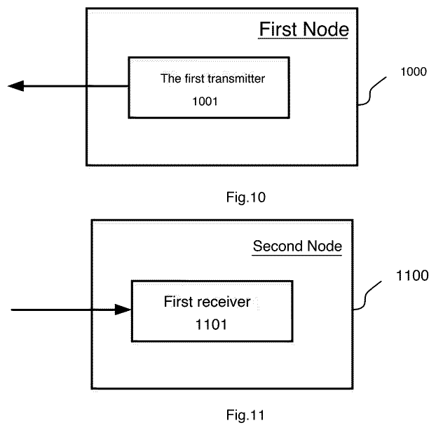

Embodiment 10 illustrates a structural block diagram of a processing device used in a first node according to an embodiment of the present application, as shown in FIG. 10. In embodiment 10, the first node device processing device 1000 is mainly composed of a first transmitter 1001.

As an embodiment, the first transmitter 1001 includes at least one of the antenna 452, transmitter/receiver 454, multi-antenna transmitter processor 457, transmit processor 468, controller/processor 459, memory 460 and data source 467 in FIG. 4 of the present application.

In embodiment 10, the first transmitter 1001 sends a first signal on a sub-link; wherein the type of the first signal is used to determine the sending timing of a first time unit, and the first time unit includes the time domain resources occupied by the first signal; the candidates for the type of the first signal include a first type of signal and a second type of signal; the first type of signal includes a reference signal used for sub-link positioning, and the second type of signal is carried on a physical sub-link channel.

As an embodiment, when the type of the first signal is the first category signal, whether the time domain resources occupied by the first signal are used within a first time window to determine the sending timing of the first time unit.

As an embodiment, when the type of the first signal is the second type of signal, the sending timing of the first time unit is the uplink sending timing of the first node.

As an embodiment, the type of the first signal is the first type of signal; when the time domain resources occupied by the first signal are within the first time window, the sending timing of the first time unit is the first sending timing; when the time domain resources occupied by the first signal are outside the first time window, the sending timing of the first time unit is the uplink sending timing of the first node.

As an embodiment, the multiple first-type signals sent by the first node in the first time window all adopt the first sending timing.

As an embodiment, the first sending timing remains unchanged within the first time window.

As an embodiment, the first node 1000 is a user equipment.

As an embodiment, the first node 1000 is a relay node.

As an embodiment, the first node 1000 is an RSU.

### EXAMPLE 11

Embodiment 11 illustrates a structural block diagram of a processing device used in a second node according to an embodiment of the present application, as shown in FIG. 11. In embodiment 11, the second node device processing device 1100 is mainly composed of a first receiver 1101.

As an embodiment, the first receiver 1101 includes at least one of the antenna 420, the transmitter/receiver 418, the multi-antenna receiving processor 472, the receiving processor 470, the controller/processor 475, and the memory 476 in FIG. 4 of the present application.

In embodiment 11, the first receiver 1101 receives a first signal on a sub-link; wherein the type of the first signal is used to determine the sending timing of a first time unit, and the first time unit includes the time domain resources occupied by the first signal; the candidates for the type of the first signal include a first type of signal and a second type of signal; the first type of signal includes a reference signal used for sub-link positioning, and the second type of signal is carried on a physical sub-link channel.

As an embodiment, when the type of the first signal is the first category signal, whether the time domain resources occupied by the first signal are used within a first time window to determine the sending timing of the first time unit.

As an embodiment, when the type of the first signal is the second type of signal, the sending timing of the first time unit is the uplink sending timing of the first node.

As an embodiment, the type of the first signal is the first type of signal; when the time domain resources occupied by the first signal are within the first time window, the sending timing of the first time unit is the first sending timing; when the time domain resources occupied by the first signal are outside the first time window, the sending timing of the first time unit is the uplink sending timing of the sender of the first signal.

As an embodiment, a plurality of first-category signals sent by the sender of the first signal in the first time window all adopt the first sending timing.

As an embodiment, the first sending timing remains unchanged within the first time window.

As an embodiment, the second node 1100 is a user equipment.

As an embodiment, the second node 1100 is a relay node.

As an embodiment, the second node 1100 is an RSU.

A person of ordinary skill in the art can understand that all or part of the steps in the above method can be completed by instructing the relevant hardware through a program, and the program can be stored in a computer-readable storage medium, such as a read-only memory, a hard disk or an optical disk. Optionally, all or part of the steps in the above embodiment can also be implemented using one or more integrated circuits. Accordingly, each module unit in the above embodiment can be implemented in the form of hardware or in the form of a software function module, and the present application is not limited to any specific form of software and hardware combination. The first node device in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The second node device in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The user equipment or UE or terminal in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The base station equipment or base station or network side equipment in this application includes but is not limited to macrocellular base stations, microcellular base stations, home base stations, relay base stations, eNB, gNB, transmission receiving nodes TRP, GNSS, relay satellites, satellite base stations, aerial base stations and other wireless communication equipment.

The above is only a preferred embodiment of the present application and is not intended to limit the protection scope of the present application. Any modification, equivalent replacement, improvement, etc. made within the spirit and principle of the present application shall be included in the protection scope of the present application.

1. A first node for wireless communication, comprising:
a first transmitter, configured to send a first signal on a sidelink;
wherein a type of the first signal is used to determine a sending timing of a first time unit, and the first time unit includes a time domain resource occupied by the first signal; a type of candidate of the first signal includes a first type of signal and a second type of signal; and the first type of signal includes a reference signal used for sidelink positioning, and the second type of signal is carried on a physical sidelink channel.

2. The first node according to claim 1, wherein when the type of the first signal is the first type of signal, whether a time domain resource occupied by the first signal is within a first time window is used to determine the sending timing of the first time unit.

3. The first node according to claim 1, wherein when the type of the first signal is the second-type signal, the sending timing of the first time unit is an uplink sending timing of the first node.

4. The first node according to claim 3, wherein the type of the first signal is the first-type signal; when a time domain resource occupied by the first signal is within the first time window, the sending timing of the first time unit is a first sending timing; and when a time domain resource occupied by the first signal is outside the first time window, the sending timing of the first time unit is an uplink sending timing of the first node.

5. The first node according to claim 4, wherein a plurality of first-type signals sent by the first node in the first time window all adopt the first sending timing.

6. The first node according to claim 5, wherein the first sending timing remains unchanged in the first time window.

7. A second node for wireless communication, comprising:
a first receiver, configured for receiving a first signal on a sidelink;
wherein a type of the first signal is used to determine a sending timing of a first time unit, and the first time unit includes a time domain resource occupied by the first signal; a type of candidate of the first signal includes a first type of signal and a second type of signal; and the first type of signal includes a reference signal used for sidelink positioning, and the second type of signal is carried on a physical sidelink channel.

8. The second node according to claim 7, wherein when the type of the first signal is the first type of signal, whether a time domain resource occupied by the first signal is within a first time window is used to determine the sending timing of the first time unit.

9. The second node according to claim 7, wherein when the type of the first signal is the second-type signal, the sending timing of the first time unit is an uplink sending timing of a sender of the first signal.

10. The second node according to claim 9, wherein the type of the first signal is the first-type signal; when a time domain resource occupied by the first signal is within the first time window, the sending timing of the first time unit is a first sending timing; and when a time domain resource occupied by the first signal is outside the first time window, the sending timing of the first time unit is an uplink sending timing of a sender of the first signal.

11. The second node according to claim 10, wherein a plurality of first-type signals sent by a sender of the first signal in the first time window all adopt the first sending timing.

12. The second node according to claim 11, wherein the first sending timing remains unchanged in the first time window.

13. A method in a first node for wireless communication, comprising:
sending a first signal on a sidelink;
wherein a type of the first signal is used to determine a sending timing of a first time unit, and the first time unit includes a time domain resource occupied by the first signal; a type of candidate of the first signal includes a first type of signal and a second type of signal; and the first type of signal includes a reference signal used for sidelink positioning, and the second type of signal is carried on a physical sidelink channel.

14. The method according to claim 13, wherein when the type of the first signal is the first type of signal, whether a time domain resource occupied by the first signal is within a first time window is used to determine the sending timing of the first time unit.

15. The method according to claim 13, wherein when the type of the first signal is the second-type signal, the sending timing of the first time unit is an uplink sending timing of the first node.

16. The method according to claim 15, wherein the type of the first signal is the first-type signal; when a time domain resource occupied by the first signal is within the first time window, the sending timing of the first time unit is a first sending timing; and when a time domain resource occupied by the first signal is outside the first time window, the sending timing of the first time unit is an uplink sending timing of the first node.

17. The method according to claim 16, wherein a plurality of first-type signals sent by the first node in the first time window all adopt the first sending timing.

18. The method according to claim 17, wherein the first sending timing remains unchanged in the first time window.

19-24. (canceled)
